(19) United States
(12) Patent Application Publication
(10) Pub. No.: US 2026/0298193 A1
(43) Pub. Date: Oct. 1, 2026

(54) AUTOMATION AND CONTROL SYSTEM APPLIED TO ENERGY GENERATION SYSTEMS IN HYDROELECTRIC PLANTS

(71) Applicants: REIVAX AUTOMAÇÃO E CONTROLE LTDA., Florianopolis (BR); RIO PARANAPANEMA ENERGIA S.A., Sao Paulo (BR)

(72) Inventors: Gregori Picolotto Conterato, Florianopolis (BR); Leonardo Augusto Weiss, Florianopolis (BR); Talles Augusto Bragagnolo Spada, Erechim (BR); Victor Juliano De Negri, Florianopolis (BR); Vinícius Vigolo, Florianopolis (BR); Tiago Nunes De Sousa, Florianopolis (BR)

(21) Appl. No.: 19/476,988

(22) PCT Filed: Apr. 19, 2024
(86) PCT No.: PCT/BR2024/050164

§ 371 Date: Oct. 20, 2025

(30) Foreign Application Priority Data
Apr. 20, 2023 (BR) 1020230075762

(51) Int. Cl. F03B 15/18; F15B 20/00

(52) U.S. Cl. CPC F03B 15/18; F15B 20/00; F05B 2270/107; F05B 2270/328; F05B 2270/605; F05B 2270/706

(57) ABSTRACT

“AUTOMATION AND CONTROL SYSTEM APPLIED TO ENERGY GENERATION SYSTEMS IN HYDROELECTRIC PLANTS”, wherein said automation and control system comprises a set of pneumatic actuators (1), a source of compressed air, a set of pneumatic valves (3 and 4), at least one linear position transducer (5), a set of emergency valves (6 and 7) and a PID controller (C), responsible for controlling the position of said pneumatic actuators (1) during the operation of the hydroelectric plant and in case of emergency stops, based on the activation of the pneumatic valves (3 and 4) and emergency valves (6 and 7).

### FIELD OF APPLICATION

The present invention patent is related to the field of mechanical engineering and automation, more specifically to the development of automation and control systems for energy generation turbines with moving blades or needles, controlling the rotational movement of the generators/energy generation turbines, particularly using pneumatic or hydropneumatic actuators.

Said automation and control system allows angular adjustment of the blades or needles that control the flow rate directed towards motors or hydraulic turbines to control and optimize the energy generation process. The system further allows to increase the operational safety of the plant, since in the event of a failure, the pneumatic or hydropneumatic components lock the actuator in a pre-determined position, preventing the turbine from rotating.

### STATE OF THE ART

Energy generation turbines are widely known in the state of the art, allowing the generation of power through barrages or dams. Barrages create a reservoir or hydroelectric basin, producing a waterfall, which can be used to move the turbine blades and rotor. Similarly, for turbine applications for energy generation by burning fossil fuels (natural gas, coal), with the burner exhaust products directed to the turbine inlet, moving the turbine rotor blades. In both cases, the turbine is connected to a rotating electrical generator, which converts the turbine mechanical energy into electrical energy.

To optimize efficiency and control the power generated by the energy generation process, parameters such as the flow rate and pressure at the turbine inlet can be adjusted by opening the valves in the barrage or by the amount of burned fossil fuel, increasing the rotation and the torque and consequently the amount of electrical energy generated in the generator.

Furthermore, the turbine efficiency can be changed during the energy generation process through the use of turbines with moving blade rotors. Turbines with moving blades are widely known in the state of the art and used to increase the efficiency of the energy generation process. The blades can also be used to control the amount of electrical energy generated, keeping the rotation of the turbine and generator constant and the energy in the electrical network without voltage and frequency fluctuations, even if variations occur in the flow rate and pressure of the fluid at the inlet of the turbine.

In the case of hydroelectric energy generation turbines, the generation process is strongly dependent on climatic effects, such as droughts or excessive rains and the volume of water in the barrage reservoirs. In cases where the variation in the water column is large in a short period of time, a greater opening of the blades is necessary to maintain the same generated power. When the machine stops, phenomena such as water hammer, cavitation or rotation above design limits may occur, and, in these cases, an emergency stop system is necessary, which moves the turbine blades or needles at a controlled speed, locking the actuators so that there is no flow rate passage to the turbine, that is, they are locked in a safe position, reducing the risk of damage to the turbine and generator components.

Usually, the adjustment of the angular position of the blade is achieved by means of hydraulic actuators, which disadvantageously present a high maintenance cost, since, in order to carry out maintenance on hydraulic systems, it is necessary to remove, store, filter the oil and carry out flushing procedures in the hydraulic lines.

In addition, disadvantageously, the use of actuators with hydraulic drive has a high risk of leaks, and, in the case of hydroelectric plants, it also presents a high environmental risk due to oil leaking into rivers or the water reservoir itself.

An alternative to the hydraulic actuator system for controlling the rotation of mobile blades or needles of turbines is the use of pneumatic actuators, which advantageously, in the event of a leak in the pneumatic lines, do not cause environmental accidents.

Document CN109209974A discloses the automation and control system of an air compressor with movable blades using double-acting pneumatic actuators with a blade position detection mechanism and pressure variation at the compressor outlet. The pressure at the compressor outlet and the blade position are fed into the control loop to optimize the process efficiency. Although the compressor operates in the opposite way to the turbine, since said compressor converts electrical energy from the motor into potential mechanical energy to increase the pressure in the fluid, the same concept can be applied to turbines, taking advantage of the potential mechanical energy of the water column in the barrage to generate electrical energy.

A disadvantage of document CN109209974A is the fact that the air flow rate control for the actuator is carried out by a single three-position solenoid directional valve and end-of-stroke sensors, and the solution does not allow the adjustment of the valve activation and closing curves to reduce the risk of water hammer, rotor operation above specified speeds or speed-controlled load movements/taking.

Another disadvantage of document CN109209974A is that it does not present a blade position locking mechanism in the event of failure of the pneumatic components or in the event of the need for emergency stops.

Document CN105068424A discloses the closed dynamic loop control model applied to the position adjustment of energy generation turbine blades, with the control model using pneumatic actuator position sensors and flow rate meter to optimize efficiency of energy generation.

Disadvantageously, the system is not fed back to reduce or increase the speed of movement of the blades, in order to reduce the risk of water hammers or speeds above the turbine operating limit. In addition, it uses flow rate meters and such equipment has high acquisition and maintenance costs.

In this way, it is understood that the use of control systems in turbines with moving blades is already known; however, according to the state of the art, the use of hydraulic actuators presents a high environmental risk and difficulty in maintenance due to of the oil used in the hydraulic line. In addition, the lack of an emergency system integrated into the automation and control system, which allows the positioning of the blade in a condition that does not pose any risk to the operation of the turbine, increases the possibility of failure.

Thus, with the aim of overcoming shortcomings in the state of the art, it is an objective of the present invention to provide, by means of pneumatic actuators and a set of pneumatic valves, the control of the position of energy generation turbine rotor blades. The arrangement of the valves can comprise several configurations depending on the layout of the energy generation plant.

Another objective of the present invention is to provide a safety and emergency stop system that locks the actuator in a predetermined position that leads to the closure of the water passage to the turbine, which begins to stop, and reduces the risk of damage to internal components of the turbine and energy generator.

As another way to characterize the emergency situation, there are leaks or pressures in the pneumatic circuit power supply below the operating limits of the pneumatic circuit.

In this way, the present invention allows the control of the position of the blades of an energy generation turbine, allowing to optimize the process performance through a set of pneumatic components, which advantageously presents lower maintenance costs, greater ease of maintenance and lower risk of environmental accidents compared to solutions that use oil. Furthermore, advantageously, it is not necessary to monitor the level and temperature of the working fluid.

Schematic figures of a particular embodiment of the invention are presented below, the dimensions and proportions of which are not necessarily the real ones, as the figures have only the purpose of didactically presenting its various aspects, whose coverage of protection is determined only by the scope of attached claims.

### BRIEF DESCRIPTION OF THE DRAWINGS

The object of the present invention will be better understood in light of the detailed description that follows in its preferred, but not limiting, embodiment, which is illustrated by the attached schematic drawings:

FIG. 1 illustrates a schematic drawing of the pneumatic valve diagram of the automation and control system of an energy generation turbine.

FIG. 2 illustrates the control loop of the PID controller (C).

### DETAILED DESCRIPTION

As represented by the attached figures, the present invention refers to an automation and control system applied to energy generation systems by hydroelectric plants, controlling the position of the moving blades or needles of an energy generation turbine by using actuators, preferably pneumatic actuators.

The automation and control system (S) allows the angular adjustment of the motor or hydraulic turbine blades, in order to control and optimize performance during the energy generation process. The automation and control system (S) also increases the plant operational safety, since, in the event of a failure, the pneumatic or hydropneumatic components lock the actuator in a predetermined position, preventing the turbine blades from rotating.

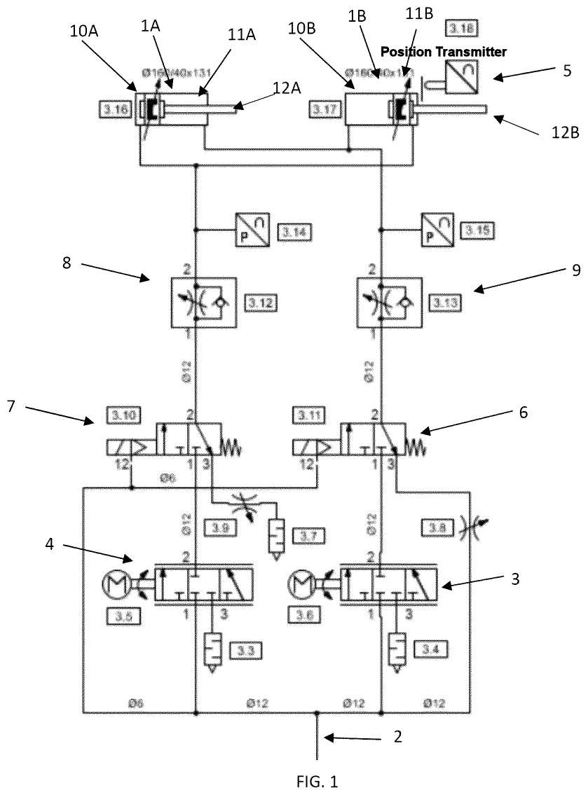

In this way, as illustrated in FIG. 1, the automation and control system (S) comprises a set of actuators (1), equipped with at least two actuators (1A) and (1B), wherein the actuator (1A) comprises chambers (10A and 11A) and a plunger (12A), while the actuator (1B) comprises chambers (10B and 11B) and a plunger (12B). It will be understood that the automation and control system (S) may comprise an actuator, such that said actuator is capable of moving the blades. The set of actuators (1) is connected to a source of compressed air (2) or to a hydraulic source, and at least one linear transducer (5) for checking the position of at least one of the actuators of the set of actuators (1), to control the angulation of a set of blades of an energy generation turbine, since the plungers (12A and 12B) are connected to the blades of said energy generation turbine.

At least one actuator of the set of actuators (1) is connected to at least one position transducer (5), said position transducer (5) measuring the retracting or advancing displacement of each plunger of each actuator.

Still according to FIG. 1, the automation and control system (S) comprises a pneumatic circuit that feeds, through the source of compressed air (2), a set of pneumatic valves (3 and 4) arranged in parallel each other and regulate the pressure at the inlet of a set of emergency valves (6 and 7) also arranged parallel to each other, so that the pneumatic valves (3 and 4) are in series with said set of emergency valves (6 and 7), which are arranged between said set of pneumatic valves (3 and 4) and a set of flow rate regulating valves (8 and 9) for controlling the linear displacement speed of each actuator of the set of actuators (1).

Advantageously, the set of flow rate regulating valves (8 and 9) controls the linear displacement speed of each actuator of the set of actuators (1) by regulating the flow rate. Thus, said set of flow rate regulating valves (8 and 9) prevents closing too quickly, which could generate a water hammer, or prevents closing too slowly, which could generate an underpressure in the conduit and an acceleration of the turbine or overspeed of the turbine, so that both forms, fast or slow, can cause damage to the structure of the hydroelectric plant.

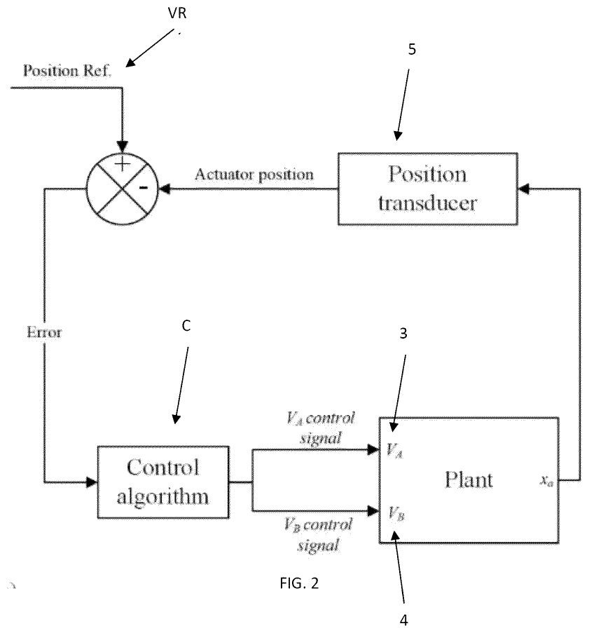

According to FIGS. 1 and 2, the automation and control system(S), in normal operation, works following the following steps:
i. The PID controller (C) receives a signal from at least one position transducer (5) of at least one actuator (1A, 1B);
ii. The PID controller (C) compares the actual position of each actuator (1A, 1B) with a predetermined reference value (VR);
iii. If the actual and predetermined positions are different, the source of compressed air (2) supplies air to the pneumatic valves (3 and 4), the opening and closing thereof being controlled by the PID (C);
iv. The air flow rate passes through the set of emergency valves (6 and 7) until it reaches the set of flow rate regulating valves (8 and 9), which controls the advance or retreat speed of each actuator (1A, 1B);
v. The actuators (1A and 1B) move the turbine blades to the reference position (VR).

Thus, when the valve (3) is activated, simultaneously, the actuator (1A) retracts the plunger (12A) due to the reduction in pressure in the chamber (10A) which is relieved by the pneumatic valve (4), while the actuator (1B) advances the plunger (12B) due to the depressurization of the chamber (11B) and the pressurization of the chamber (10B).

In an analogous way, to move the actuators in the opposite direction, the automation and control system (S) activates the pneumatic valve (4) and pressurizes the chambers (10A and 11B), so that the chambers (10B and 11A) are depressurized by venting the pressure using the pneumatic valve (3).

Thus, advantageously, the automation and control system (S) allows better adjustment of the turbine blades of the hydroelectric plant, increasing performance in generating electrical energy, as well as reducing fluctuations in the network.

In a preferred embodiment of the invention, the automation and control system (S) is provided with safety control, where said system operates in an emergency condition.

Thus, the valves are switched when the PID controller (C) receives an emergency situation signal, which may be generated by a failure in the automation and control system itself (S) or any other critical system of the plant.

Thus, the automation and control system (S), in an emergency situation, operates as follows:
a) A PID controller (C) receives an emergency situation signal;
b) The PID controller (C) simultaneously switches a set of emergency valves (6 and 7), in order to isolate a set of pneumatic valves (3 and 4).
c) The emergency valve (7) connects a chamber (10A) of an actuator (1A) and a chamber (11B) of an actuator (1B) to the atmospheric pressure, in order to release the pressure contained in said chambers (10A and 11B);
d) Simultaneously with step “c”, the emergency valve (6) connects a chamber (11A) of the actuator (1A) and a chamber (10B) of the actuator (1B) to the pressure of the pneumatic circuit through a source of compressed air (2);
e) A set of flow rate regulating valves (8 and 9) controls the linear displacement speed of the actuators (1A and 1B);
f) A plunger (12A) of the actuator (1A) fully retracts, while a plunger (12B) of the actuator (1B) advances fully at a pre-defined speed and controlled by a set of flow rate regulating valves (8 and 9);
g) At least one linear transducer (5) checks the position of at least one of the actuators (1A and 1B) and sends a signal to the PID (C) indicating the safe position.
h) The system does not require monitoring the level and temperature of the working fluid.

In this way, the present invention provides greater safety for hydroelectric plants, in addition to providing greater performance in the generation of electrical energy.

The technician skilled on the subject will readily realize, from the description and represented drawings, several ways of carrying out the invention without departing from the scope of the attached claims.

1. AN “AUTOMATION AND CONTROL SYSTEM APPLIED TO ENERGY GENERATION SYSTEMS IN HYDROELECTRIC PLANTS” that comprises a set of actuators (1), equipped with at least two actuators (1A) and (1B), which comprise chambers (10A) and (11A) and chambers (10B) and (11B), respectively, with said set of actuators (1) being connected to a source of compressed air (2) and at least one linear transducer (5) for checking the position of at least one of the actuators of the set of actuators (1) for controlling the angulation of a set of blades of an energy generation turbine, characterized in that
the automation and control system (S) comprises a pneumatic circuit that feeds, through the source of compressed air (2), a set of pneumatic valves (3 and 4) arranged parallel to each other that regulate the pressure at the inlet of set of emergency valves (6 and 7) also arranged parallel to each other, so that the pneumatic valves (3 and 4) are in series with said set of emergency valves (6 and 7), which are arranged between the said set of pneumatic valves (3 and 4) and a set of flow rate regulating valves (8 and 9) for controlling the linear displacement speed of each actuator of the set of actuators (1);
the set of emergency valves (6 and 7) fluidly isolate the set of pneumatic valves (3 and 4) in the event of an emergency;
the emergency valve (6) simultaneously feeds the chambers (11A) and (10B) of the actuators (1A) and (1B), respectively, while the emergency valve (7) simultaneously feeds the chambers (10A) and (11B) of the actuators (1A) and (1B), respectively, in order to linearly displace the plungers (12A and 12B) and consequently angularly the blades (P) of the energy generation turbine (T).

2. THE “AUTOMATION AND CONTROL SYSTEM APPLIED IN ENERGY GENERATION SYSTEMS IN HYDROELECTRIC PLANTS” according to claim 1, characterized in that the chamber (10A) of the actuator (1A) is fluidly connected with the chamber (11B) of the actuator (1B), while the chamber (11A) of the actuator (1A) is fluidly connected with the chamber (10B) of the actuator (1B), so that the actuators (1A and 1B) remain in balance and the plungers (12A and 12B) have the same displacement in the opposite direction.

3. THE “AUTOMATION AND CONTROL SYSTEM APPLIED TO ENERGY GENERATION SYSTEMS IN HYDROELECTRIC PLANTS”, which uses the automation system (S) of claim 1, characterized in that the automation and control system (S) operates according to the following steps:
a) A PID controller (C) receives an emergency situation signal;
b) The PID controller (C) simultaneously switches a set of emergency valves (6 and 7), in order to isolate a set of pneumatic valves (3 and 4);
c) The emergency valve (7) connects a chamber (10A) of an actuator (1A) and a chamber (11B) of an actuator (1B) to the atmospheric pressure, in order to release the pressure contained in said chambers (10A and 11B);
d) Simultaneously with step “c”, the emergency valve (6) connects a chamber (11A) of the actuator (1A) and a chamber (10B) of the actuator (1B) to the pressure of the pneumatic circuit through a source of compressed air (2);
e) A set of flow rate regulating valves (8 and 9) controls the linear displacement speed of each actuator (1A and 1B);
f) A plunger (12A) of the actuator (1A) fully retracts, while a plunger (12B) of the actuator (1B) advances fully at a pre-defined speed and controlled by a set of flow rate regulating valves (8 and 9);
g) At least one linear transducer (5) checks the position of at least one of the actuators (1A and 1B) and sends a signal to the PID (C) indicating the safe position of a set of turbine blades.
